(19) United States
(12) Patent Application Publication
(10) Pub. No.: US 2007/0233752 A1
(43) Pub. Date: Oct. 4, 2007

(54) Method and apparatus to reclaim nonvolatile memory space

(76) Inventors: Kiran Bangalore, Folsom, CA (US); Patrick C. McGinty, Rancho Cordova, CA (US); Lawrence Chang, Rancho Cordova, CA (US)

Correspondence Address: KACVINSKY LLC;C/O INTELLEVATE, P.O. BOX 52050, MINNEAPOLIS, MN, 55402, US

(21) Appl. No.: 11/395,982

(22) Filed: Mar. 30, 2006

(51) Int. Cl. G06F 17/30

(52) U.S. Cl. 707/202

(57) ABSTRACT

Various embodiments for reclaiming nonvolatile memory space are described. In one embodiment, an apparatus may include a nonvolatile memory to perform reclaim operations to recover memory space from a reclaim block containing stored information. The reclaim block may be associated with a reclaim page to store one or more reclaim states indicating progress of the reclaim operations. In some cases, the reclaim states may be written one after another to the reclaim page so that reclaim operations comply with sequential addressing as well as restrictions against bit-twiddling. If power-loss were to occur during reclaim, the reclaim states written to the reclaim page may be used for system recovery. Other embodiments are described and claimed.

### BACKGROUND

Nonvolatile memory, such as flash memory, is capable of retaining digital information until erased. Most flash devices are not bit erasable and require erasing to be performed at block granularity (e.g., 16 KB for NAND, 128K for NOR). In a flash device, reclaim operations may be performed to recover flash memory space consumed by invalid data, such as deleted files. The reclaim operations generally may require a complete block erase and may involve targeting a reclaim block containing invalid data and valid data such as active files, copying any valid data in the reclaim block to a spare block, and then erasing the reclaim block. The space that was consumed by invalid data in the reclaim block is recovered as “free space” in the spare block.

Current methods for erasing flash memory to reclaim space may involve a process known as “bit-twiddling” in which single bits are altered to indicate the progress of certain file system operations during reclaim. Bit-twiddling may help to restore a file system up until a desired point and may provide robust power-loss recovery. The process of bit-twiddling generally requires the ability to bit-alter areas of flash memory reliably and the ability to go back to previously programmed areas of the flash memory.

Moving forward, flash memory is expected to restrict the ability to perform bit-twiddling. For example, flash memory may restrict the ability to alter a single bit of memory reliably in one operation and may not allow the same bits within a certain granularity (e.g., within one byte) to be changed more than once. In addition, some flash memory devices enforce a sequential addressing requirement that restricts the ability to go back to previously programmed areas of the flash memory. For example, enforcing sequential addressing at a page granularity may allow going back and writing within a page but may restrict the ability to go back and write to previous pages with a flash block.

Therefore, there is a need for improved systems and techniques to reclaim nonvolatile memory space under sequential addressing and/or without bit-twiddling while satisfying power-loss recovery requirements of the file system.

### BRIEF DESCRIPTION OF THE DRAWINGS

FIG. 1 illustrates one embodiment of a computing system.

FIGS. 2A-C illustrate one embodiment of a nonvolatile memory.

FIG. 3 illustrates one embodiment of a logic flow.

### DETAILED DESCRIPTION

Various embodiments are directed to reclaiming nonvolatile memory space, such as flash memory space. The nonvolatile memory may include nonvolatile memory blocks to store information. Each nonvolatile memory block may be divided into pages or regions. In a NAND flash memory, for example, each page may comprise a 512 byte region that has a 16 byte region to store error correct code (ECC) information to protect the reliability of the region. In a NOR flash memory, a block may comprise regions such as 16 byte control mode regions of 1 KB object mode regions.

In one embodiment, a nonvolatile memory may comprise a plurality of nonvolatile memory blocks, and each of the nonvolatile memory blocks may include a plurality of pages. One or more nonvolatile memory blocks containing stored information may be configured as reclaim blocks to recover nonvolatile memory space. One or more nonvolatile memory blocks may be configured as spare blocks to copy stored information from one or more reclaim blocks. The reclaim block may be associated with a reclaim page to store one or more reclaim states indicating progress of reclaim operations.

In various implementations, reclaim operations may be initiated by writing a recovery state to the reclaim page of a reclaim block. The reclaim operations may progress by copying stored information from the reclaim block to a spare block. After the stored information has been copied to the spare block, an erasing state may be written to the reclaim page of the reclaim block. The reclaim operations may continue by erasing the reclaim block, including the reclaim page, to recover nonvolatile memory space. An erased state may be written to a page of an erased reclaim block to indicate that the nonvolatile block may be configured as a new spare block.

In various embodiments, the nonvolatile memory may restrict the ability to perform bit-twiddling and may enforce a sequential addressing requirement that restricts the ability to go back to previously programmed areas of the nonvolatile memory. In such embodiments, once reclaim operations begin and information is copied from a reclaim block to a spare block, it may not be possible to go back to previous pages of the reclaim block to record reclaim states. However, because the reclaim states are written one after another to the last page of each reclaim block, the reclaim operations may comply with sequential addressing as well as restrictions against bit-twiddling. Moreover, if power-loss were to occur during reclaim, the file system may recover using the reclaim states written to the reclaim page.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

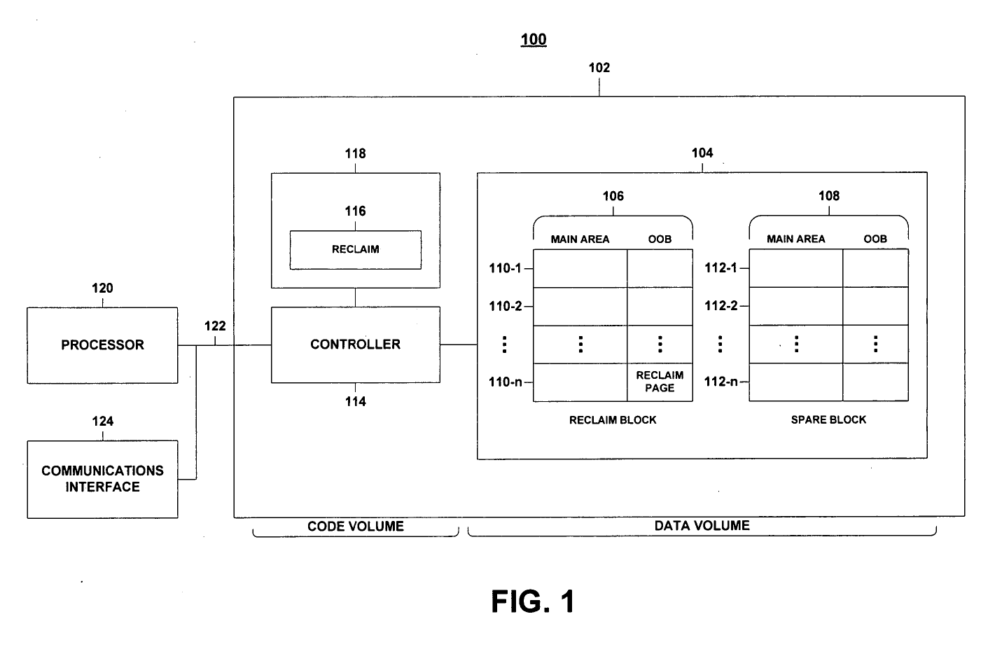

FIG. 1 illustrates a block diagram of one embodiment of a computing system 100. The computing system 100 generally may comprise various physical or logical components implemented as hardware, software, or any combination thereof, as desired for a given set of design parameters or performance constraints.

In various embodiments, the computing system 100 may comprise or be implemented by a wireless device such as a mobile telephone, a handheld computer, a personal digital assistant (PDA), a combination mobile telephone/PDA, a handset, a one-way pager, a two-way pager, a data transmission device, a wireless access point, a base station (BS), a subscriber station (SS), a mobile subscriber center (MSC), a radio network controller (RNC), and so forth. In such embodiments, the computing system 100 may comprise one more interfaces and/or components for wireless communication, such as one or more antennas, transmitters, receivers, transceivers, amplifiers, filters, control logic, and so forth.

Although some embodiments may be described with the computing system 100 implemented as a wireless device by way of example, it may be appreciated that the embodiments are not limited in this context. For example, in some embodiments, the computing system 100 may comprise, or be implemented as a personal computer (PC), a desktop computer, a laptop computer, a notebook PC, a workstation, a terminal, a server, an appliance, a PDA, a digital music player, a set-top box (STB), or other type of computer system or sub-system.

The computing system 100 may comprise a nonvolatile memory 102. The nonvolatile memory 102 may comprise, for example, one or more chips or integrated circuits (ICs). In various embodiments, the nonvolatile 102 may be implemented by flash memory, such as a NAND or a NOR flash memory. Examples of flash memory include, for example, Intel® Flash Memory products, such as StrataFlash® Cellular Memory and Intel® Wireless Flash Memory, and other types of flash memory.

As shown in FIG. 1, the nonvolatile memory 102 may be implemented as a NAND flash memory. It can be appreciated that the nonvolatile memory 102 may be implemented as a NOR flash memory in other embodiments. It also can be appreciated that although some embodiments may be described with the nonvolatile memory 102 implemented by flash memory, the embodiments are not limited in this context. For example, the nonvolatile memory 102 may be implemented by polymer memory, ferroelectric memory, magnetic memory, or other nonvolatile storage medium.

The nonvolatile memory 102 may be arranged to store various types of information such as data, instructions, and code. The information may include, for example, image information (e.g., digital photographs, user interfaces, Web pages, graphics), audio information (e.g., music, sounds, ring tones), video information, audio/video (A/V) information (e.g., video files, video clips, movies, broadcast programming), voice information, textual information (e.g., encryption keys, serial numbers, e-mail messages, text messages, instant messages, contact lists, telephone numbers, task lists, calendar entries, hyperlinks), numerical information, alphanumeric information, character symbols, and so forth. The information may include command information, control information, routing information, processing information, system file information, system library information, software (e.g., operating system software, file system software, application software, game software), firmware, an application programming interface (API), a program, an applet, a subroutine, an instruction set, an instruction, computing code, logic, words, values, symbols, and so forth. In various embodiments, instructions and/or code may be stored contiguously in the nonvolatile memory 102 to allow the instructions and/or code to be executed-in-place (XIP). The embodiments are not limited in this context.

The information stored by the nonvolatile memory 102 may comprise static and/or dynamic information. Static information may comprise any information that may not be altered, changed or updated. Examples of static information may include read-only data, instructions, and code. Dynamic information may comprise any information that may be altered, changed, and/or updated. Examples of dynamic information may include read/write data, instructions, and code. The embodiments are not limited in this context.

The nonvolatile memory 102 may store both code and data and may store code in one area of the nonvolatile memory 102 and may store data in another area of the nonvolatile memory 102. The area of the nonvolatile memory 102 where code is stored may be referred to as the code volume of the nonvolatile memory 102. The area of the nonvolatile memory 102 where data is stored may be referred to as the data volume of nonvolatile memory 102. The embodiments are not limited in this context.

In various embodiments, the nonvolatile memory 102 may be arranged to store information in a file system including one or more arrays, such as a nonvolatile memory array 104. The nonvolatile memory array 104 may be implemented, for example, by an array of floating gate transistors or nonvolatile memory cells (e.g., flash memory cells). The nonvolatile memory cells may comprise single-bit cells that allow one bit of information to be stored in each cell and/or multi-level cells that allow more than one bit of information to be stored in each cell. For example, two bits of information may be stored in a multi-level cell by controlling programming and reading in order to have four states within a single transistor.

The nonvolatile memory array 104 may comprise a plurality of nonvolatile memory blocks to store information, such as nonvolatile memory blocks 106, 108. Each of the nonvolatile memory blocks 106, 108 may include a plurality of memory cells capable of storing at least one bit of data. In various implementations, the nonvolatile memory array 104 may be arranged to have a symmetrical or asymmetrical blocking architecture. For example, the nonvolatile memory array 104 may comprise a symmetrically-blocked array with each nonvolatile memory block having a size of 256 kilobytes (KB). In some embodiments, the nonvolatile memory blocks 106, 108 may be grouped into partitions (e.g., 16 or 32 memory blocks per partition) within the nonvolatile memory array 104. In some cases, the nonvolatile memory 102 may be arranged to store data and code in separate partitions.

The nonvolatile memory blocks 106, 108 may be divided into a plurality of pages or regions. As shown in the embodiment of FIG. 1, the nonvolatile memory 102 may be implemented by a NAND flash memory. In this embodiment, the nonvolatile memory block 106 may comprise pages 110-1-n, and the nonvolatile memory block 108 may comprise pages 112-n, where n represents any positive integer value (e.g., n=256). Each of the pages 110-1-n, 112-1-n may include a main area and an out-of-bounds (OOB) region. The embodiments, however, are not limited to the example of FIG. 1. For example, when implemented by a NOR flash memory, the pages or regions 110-1-n, 112-1-n may not include an OOB region.

In some implementations, the pages or regions 110-1-n, 112-1-n may be programmed in one or more modes, such as an object mode or a control mode. A region programmed in object mode may be configured, for example, as a one-time write or write-restricted area for storing static information, such as objects or payloads that rarely change. A region programmed in control mode may be configured, for example, as a rewritable area that supports multiple programming operations for writing, rewriting, over-writing, augmenting, altering, changing, and/or updating dynamic information. In some cases, the full data storage capacity (e.g., 1 KB) of a region may be available for data storage. In other cases, less than the full data storage capacity (e.g., 512 bytes) of a region may be available for data storage.

The nonvolatile memory 102 may be arranged to perform reclaim operations to recover nonvolatile memory space. In various embodiments, the reclaim operations may comprise targeting or configuring one or more nonvolatile memory blocks containing stored information as reclaim blocks to recover nonvolatile memory space. As shown in the embodiment of FIG. 1, for example, the nonvolatile memory block 106 may be configured as a reclaim block to recover nonvolatile memory space.

In various implementations, the reclaim operations may be performed to free nonvolatile memory space consumed by invalid information. For example, the nonvolatile memory block 106 may be configured as a reclaim block when space consumed by invalid data is needed for new allocations. In some cases, the reclaim operations may be triggered when an amount of consumed nonvolatile memory space exceeds a certain threshold (background reclaim) and/or when additional nonvolatile memory space is required (foreground reclaim).

In various embodiments, the reclaim nonvolatile memory block 106 may be associated with a reclaim page to store one or more reclaim states indicating progress of the reclaim operations. As shown in the embodiment of FIG. 1, for example, the reclaim nonvolatile memory block 106 may comprise a reclaim page 110-n to store one or more reclaim states indicating progress of the reclaim operations. The reclaim page 110-n may comprise, for example, the last page of the reclaim nonvolatile memory block 106. The embodiments, however, are not limited in this context. For example, in some embodiments, the reclaim page may be outside of the reclaim nonvolatile memory block 106.

In various implementations, the reclaim operations may be initiated by writing a recovery state (e.g., BLK_RECOVER) to the reclaim page 110-n of the reclaim nonvolatile memory block 106. In one embodiment, the nonvolatile memory 102 may be implemented by a NAND flash memory, and the OOB region of the reclaim page 110-n may store the reclaim states indicating progress of the reclaim operations. In other embodiments, the nonvolatile memory 102 may be implemented by a NOR flash memory, and the reclaim states may be written to the main area of the reclaim page 110-n, since an OOB region is specific to a NAND flash memory.

In various embodiments, the reclaim operations may comprise configuring one or more nonvolatile memory blocks as spare blocks to copy stored information from reclaim blocks. As shown in the embodiment of FIG. 1, for example, the nonvolatile memory block 108 may be configured as a spare block. In various implementations, at the time reclaim operations begin, the spare nonvolatile memory block 108 may be erased and contain no information. In some cases, the spare nonvolatile memory block 108 may be designated for use only during the reclaim operations.

The reclaim operations may comprise copying stored information from the reclaim nonvolatile memory block 106 to the spare nonvolatile memory block 108. In various embodiments, after the stored information has been copied from the reclaim nonvolatile memory block 106 to the spare nonvolatile memory block 108, an erasing state (e.g., BLK_ERASING) may be written to the reclaim page 110-n of the reclaim nonvolatile memory block 106.

After the stored information has been copied to the spare nonvolatile memory block 108, the reclaim operations may continue by erasing the reclaim nonvolatile memory block 106, including the reclaim page 110-n, to recover nonvolatile memory space. In some cases, the nonvolatile memory 102 may require erasing at block granularity. In various embodiments, after erasing has completed, an erased state (e.g., BLK_ERASED) may be written to the reclaim nonvolatile block 106. The erased state may be written, for example, to the first page 110-1 of the reclaim nonvolatile memory block 106. The erased state may indicate that, after being erased, the reclaim nonvolatile memory block 106 may be configured as a new spare block. In one embodiment, the nonvolatile memory 102 may be implemented by a NAND flash memory, and the erased state may be written to the OOB region of the first page 110-1. In other embodiments, the nonvolatile memory 102 may be implemented by a NOR flash memory, and the erased state may be written to the main area of the first page 110-1.

In various implementations, only valid information is copied from the reclaim nonvolatile memory block 106. In such implementations, any valid information stored in the nonvolatile reclaim block 106 is relocated to the spare nonvolatile memory block 108 before the reclaim nonvolatile memory block 106 is erased. This ensures that there is always at least one copy of valid information stored in the nonvolatile memory 102 so that if system power is lost, the valid information remains intact. In some cases, the valid information may be copied to the same relative location within the spare nonvolatile memory block 108.

In some embodiments, the nonvolatile memory 102 may be arranged to recover valid information from “bad” nonvolatile memory blocks. It is possible that in the lifetime of the nonvolatile memory 102, some of the available nonvolatile memory blocks (e.g., up to 2%) might go bad and become unreliable. In such embodiments, the reclaim operations may recover valid information from a bad nonvolatile memory block and copy the valid information to a nonvolatile memory block reserved specifically for recovering information from a bad block. For example, if it is determined that the reclaim nonvolatile memory block 106 is a bad block, a bad block state (e.g., BLK_BAD) may be written to the reclaim page 110-n after the valid information has been copied to a reserve nonvolatile memory block. At the end of the reclaim, instead of erasing the reclaim nonvolatile memory block 106 and writing an erased state to the first page 110-1, a bad block state would be written to the first page 110-1 indicating to future initializations that the reclaim nonvolatile memory block 106 is bad and unusable.

In various embodiments, the nonvolatile memory 102 may restrict the ability to perform bit-twiddling and may enforce a sequential addressing requirement at a page granularity that restricts the ability to go back to previously programmed areas of the nonvolatile memory 102. In such embodiments, once reclaim operations begin and information is copied from the reclaim nonvolatile memory block 106 to the spare nonvolatile memory block 108, it may not be possible to go back to previous pages of the reclaim nonvolatile memory block 106 to record reclaim states. However, because the reclaim states are written one after another to the reclaim page 110-n (e.g., last page) of the reclaim nonvolatile memory block 106, the reclaim operations may comply with sequential addressing as well as restrictions against bit-twiddling. Moreover, if power-loss were to occur during the reclaim operations, the file system may recover using the reclaim states written to the reclaim page 110-n.

The nonvolatile memory 102 may perform the reclaim operations using hardware, software, and/or any combination thereof, as desired for a given set of design parameters or performance constraints. In various embodiments, the nonvolatile memory 102 may be arranged to perform the reclaim operations using a controller 114 and/or a reclaim block 116. The controller 114 may comprise, for example, a microcontroller embedded in or integrated with the nonvolatile memory 102, and the nonvolatile memory 102 may comprise instructions and/or code to be executed by the controller 114.

It can be appreciated that although some embodiments may be described with the controller 114 implemented by a microcontroller, the embodiments are not limited in this context. For example, in some embodiments, the controller 114 may be implemented by a processor such as a general purpose processor, a chip multiprocessor (CMP), a dedicated processor, an embedded processor, a digital signal processor (DSP), a network processor, a media processor, an input/output (I/O) processor, a media access control (MAC) processor, a radio baseband processor, a co-processor, a microprocessor, and so forth. The controller 102 also may be implemented by an application specific integrated circuit (ASIC), a field programmable gate array (FPGA), a programmable logic device (PLD), and so forth.

In various embodiments, the nonvolatile memory 102 may comprise a reclaim module 116. The reclaim module 116 may be implemented, for example, by hardware and/or software in the nonvolatile memory 102. The reclaim module 116 may comprise, for example, instructions and/or code in the nonvolatile memory 102 to be executed by the controller 114. In various implementations, the reclaim module 116 may comprise logic for reclaiming space in the nonvolatile memory 102.

In various embodiments, the reclaim module 116 may comprise part of a file system manager 118 of the nonvolatile memory 102. The file system manager 118 may be implemented, for example, by instructions and/or code stored in the nonvolatile memory 102. In various embodiments, the file system manager 118 may comprise logic to manage and store information in the nonvolatile memory 102. The file system manager 118 may be arranged to issue read, write, and erase commands for the nonvolatile memory 102 and to translate file system volumes into memory arrays. In various implementations, the file system manager 118 may provide one or more interfaces between the hardware of the nonvolatile memory 102 and a client application and/or an operating system (OS), such as a real-time operating system (RTOS).

In various embodiments, the file system manager 118 may comprise instructions and/or code to be executed by the controller 114. In some embodiments, the controller 114 may be arranged to perform various operations for managing and storing information in the nonvolatile memory 102. The operations performed by the controller 114 may comprise, for example, standard operations such as read, program, and erase operations. The controller 114 also may be arranged to perform operations to increase and/or optimize system performance. For example, the controller 114 may allow some operations to be performed simultaneously, such as reading and executing code while programming data. The controller 114 also may allow some operations to be suspended and resumed. The controller 114 may perform various operations in one or more modes such as an asynchronous mode, synchronous mode, word mode, page mode, and burst mode, for example.

In various embodiments, the nonvolatile memory 102 may be arranged to receive information from a processor 120, such as a central processing unit (CPU), for example. In various embodiments, the controller 114 may perform one or more operations in nonvolatile memory 102 in response to information received from the processor 120. As shown, the processor 120 may comprise a discrete component separate from and coupled to the nonvolatile memory 102. In various implementations, the nonvolatile memory 102 may store instructions and/or code to be executed by the processor 120.

The processor 120 generally may be implemented using any processor or logic device. In various embodiments, the processor 120 may be implemented as a general purpose processor, a CMP, a dedicated processor, an embedded processor, a DSP, a network processor, a media processor, an I/O processor, a MAC processor, a radio baseband processor, a co-processor, a microprocessor, a controller, a microcontroller, an ASIC, a FPGA, a PLD, and so forth. In various implementations, the processor 120 may include at least one core comprising, for example, an arithmetic-logic unit (ALU) and a number of registers. The core may be arranged to execute digital logic and may provide for multiple threads of execution.

In various embodiments, the nonvolatile memory 102 may be arranged to receive information over one or more communications media 122. The communications media 122 generally may comprise any medium capable of carrying information signals such as wired communication media, wireless communication media, or a combination of both, as desired for a given implementation. The communications media 122 may comprise, for example, wired communication media such as a bus to interconnect various functional units of the computing system 100. Other examples of wired communications media may include a wire, a cable, a printed circuit board (PCB), a backplane, a switch fabric, semiconductor material, twisted-pair wire, co-axial cable, fiber optics, and so forth. An example of wireless communication media may include portions of a wireless spectrum, such as the radio-frequency (RF) spectrum. The embodiments are not limited in this context.

In various implementations, the received information may be segmented into a series of data packets. Each data packet may comprise, for example, a discrete data set having a fixed or varying size represented in terms of bits or bytes, such as 1 KB. It can be appreciated that the described embodiments are applicable to any type of content or format, such as packets, windows, files, cells, frames, fragments, units, and so forth.

In various embodiments, the nonvolatile memory 102 may be arranged to receive information through a communications interface 124. The communications interface 124 may comprises any suitable hardware, software, or combination of hardware and software that is capable of coupling the computing system 100 to one or more networks and/or network devices. The communications interface 124 may be arranged to operate with any suitable technique for controlling information signals using a desired set of communications protocols, services or operating procedures. The communications interface 124 may include the appropriate physical connectors to connect with a corresponding communications medium.

In various embodiments, the communications interface 124 may comprise one or more interfaces such as, for example, a wireless communications interface, a wired communications interface, a network interface, a transmit interface, a receive interface, a media interface, a system interface, a component interface, a switching interface, a chip interface, a controller (e.g., disc controller, video controller, audio controller), and so forth. When implemented by a wireless device or wireless system, for example, the computing system 100 may include a wireless interface comprising one or more antennas, transmitters, receivers, transceivers, amplifiers, filters, control logic, and so forth.

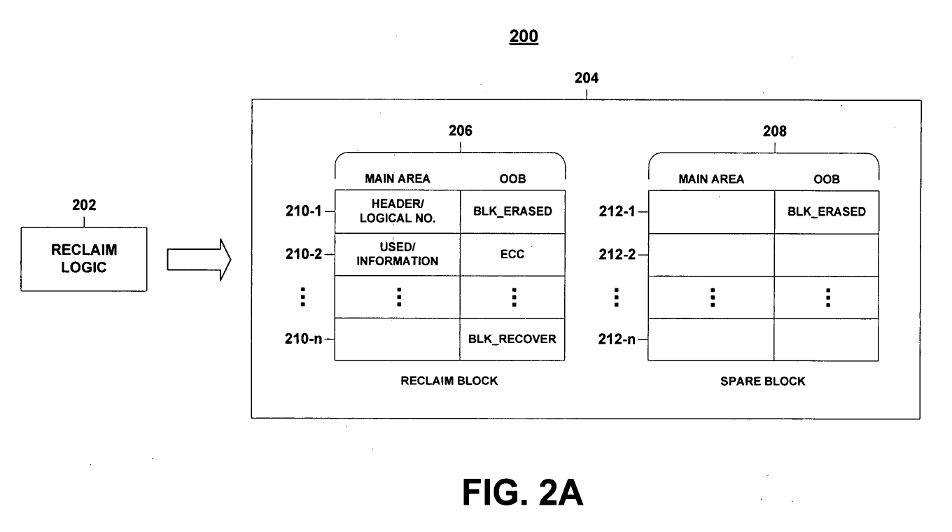

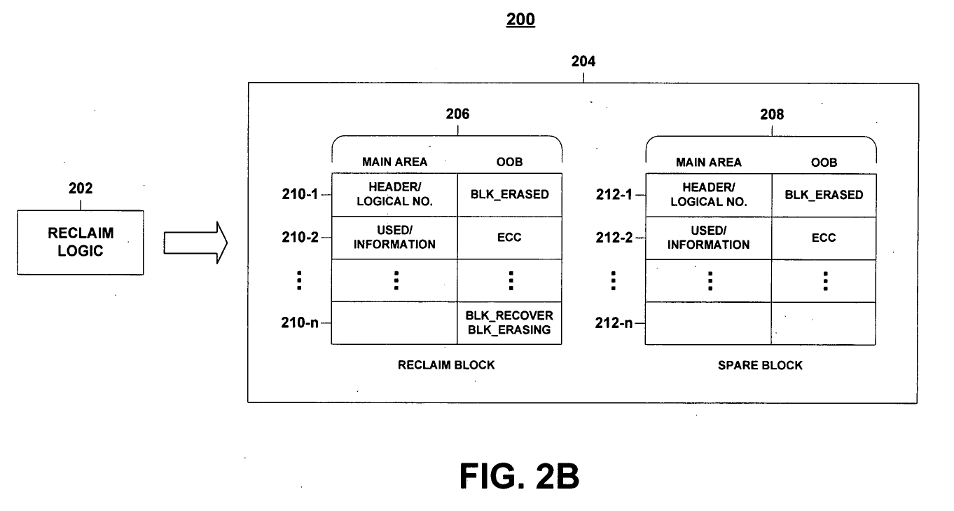

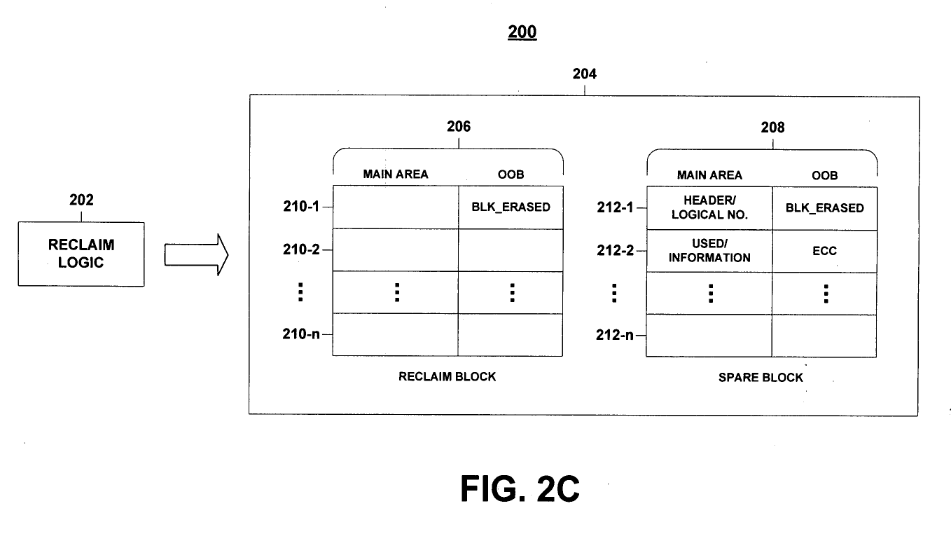

FIGS. 2A-C illustrate one embodiment of a nonvolatile memory 200. In various embodiments, the memory 200 may be implemented as the nonvolatile memory 102 of FIG. 1. The embodiments, however, are not limited in this context.

As shown, the nonvolatile memory 200 may comprise reclaim logic 202 for performing reclaim operations to recover nonvolatile memory space. In various embodiments, the reclaim logic 202 may be implemented as hardware, software, and/or any combination thereof, as desired for a given set of design parameters or performance constraints. For example, the reclaim logic 202 may be implemented by a controller (e.g., controller 114) and/or a reclaim block (e.g., reclaim block 116) comprising instructions and/or code to be executed by a controller.

Referring to FIGS. 2A-C, the nonvolatile memory array 204 may comprise a reclaim nonvolatile memory block 206 and a spare nonvolatile memory block 208. The reclaim nonvolatile memory block 206 may comprise pages 210-1-n, and the spare nonvolatile memory block 208 may comprise pages 212-n, where n represents any positive integer value (e.g., n=256). As shown, the reclaim nonvolatile memory block 206 may comprise a reclaim page 210-n (e.g., last page) to store one or more reclaim states indicating progress of the reclaim operations. In various embodiments, the nonvolatile memory 200 may be implemented by a NAND flash memory, and each of the pages 210-1-n, 212-1-n may include a main area and an out-of-bounds (OOB) region. The embodiments, however, are not limited to the example of FIG. 2.

Referring to FIG. 2A, the reclaim nonvolatile memory block 206 may comprise a first page 210-1 storing a block header and/or a logical number in a main area and a block erased state (e.g., BLK_ERASED) in an OOB region. The reclaim nonvolatile memory block 206 also may comprise one or more used pages (e.g., page 210-2) containing stored information. As shown, the used page 210-2 may store information in a main area and error-correction code (ECC) data in an OOB region. In various implementations, the reclaim operations may be initiated by writing a recovery state (e.g., BLK_RECOVER) to the reclaim page 210-n (e.g., OOB region) of the reclaim nonvolatile memory block 206 indicating that reclaim has started.

If power-loss were to occur during reclaim, the recovery state may indicate to initialization that a reclaim was in progress. When the recovery state is detected in the reclaim page 210-n during power-loss recovery, the spare nonvolatile memory block 208 will be erased, and the process of copying information from the reclaim nonvolatile memory block 206 to the spare nonvolatile memory block 208 will start over. The spare nonvolatile memory block 208 may be detected because it will either be empty or have the same logical block number as the reclaim nonvolatile memory block 206. As distinguished from the reclaim nonvolatile memory block 206, however, the spare nonvolatile memory block 208 will not have anything written to the last page 212-n.

Referring to FIG. 2B, the reclaim operations may comprise copying stored information from the reclaim nonvolatile memory block 206 to the spare nonvolatile memory block 208. As shown, the spare nonvolatile memory block 208 may comprise a first page 212-1 storing the block header and/or a logical number copied from the reclaim nonvolatile memory block 206 in a main area and a block erased state (e.g., BLK_ERASED) in an OOB region. The spare nonvolatile memory block 208 also may comprise one or more used pages (e.g., page 212-2) containing information copied from one or more used pages (e.g., 210-2) of the reclaim nonvolatile memory block 206. In various implementations, after the stored information has been copied from the reclaim nonvolatile memory block 206 to the spare nonvolatile memory block 208, an erasing state (e.g., BLK_ERASING) may be written to the reclaim page 210-n of the reclaim nonvolatile memory block 206 to indicate that copying has completely finished and that the next step is to erase the reclaim nonvolatile memory block 206.

If power-loss were to occur during the reclaim, the erasing state may indicate to initialization that all information has been copied to the spare nonvolatile memory block 208 and that the reclaim nonvolatile memory block 206 may be erased. When the erasing state is detected in the reclaim page 210-n after a power-loss, the spare nonvolatile memory block 208 does not to be erased, and the information from the reclaim nonvolatile memory block 206 does not need to be re-copied.

Referring to FIG. 2C, after the stored information has been copied to the spare nonvolatile memory block 208, the reclaim operations may continue by erasing the reclaim nonvolatile memory block 206, including the reclaim page 210-n, to recover nonvolatile memory space. In various implementations, after erasing has completed, an erased state (e.g., BLK_ERASED) may be written to the reclaim nonvolatile memory block 206. The erased state may be written, for example, to the OOB region of the first page 210-1 of the nonvolatile memory block 206. The erased state, along with the empty block header may indicate that the reclaim nonvolatile memory block 206 may be configured as a new spare block. As shown, the logical block number is but not the first page 210-1 of the reclaim nonvolatile memory block 206 no longer includes the logical block number. As shown, the first page 212-1 of the spare nonvolatile memory block 208 stores the logical block number, which is no longer stored in the first page 210-1 of the reclaim nonvolatile memory block 206. This may solidify the spare nonvolatile memory block 208 as a valid block in the system.

It can be appreciated that as writes occur to each nonvolatile memory block, previous pages are not revisited. Because the reclaim page 210-n is saved off as the last page of the reclaim nonvolatile memory block 206, writes to the reclaim page 210-n during reclaim operations do not violate sequential addressing restrictions. Furthermore, the reclaim states may be written to the reclaim page 210-n one after another, as opposed to on top of each other, as was the case with bit-twiddling.

It also can be appreciated that during power-loss recovery operations, writes to the nonvolatile memory blocks progress downwards and never backwards. In addition, bit-twiddling is unnecessary and may be avoided. Moreover, if power-loss were to occur during the reclaim operations, the file system is able to recover using the states that were written to the reclaim page 210-n.

In various implementations, the described embodiments are not exclusive to a single flash type but work for both NOR and NAND flash devices. The described embodiments may provide a turn-key solution for providing unified reclaim operations for both NAND and NOR flash devices. It can be appreciated that in a NOR device, the reclaim states may be written to a main area of a page or region since an OOB region is specific to NAND.

Because the reclaim operations are performed without the need to go back to previous pages or to perform bit-twiddling, the reclaim operations are less restrictive and more adaptive to future nonvolatile memory devices having sequential addressing requirements and restrictions against bit-twiddling. In addition, the reclaim operations may be performed using less code while maintaining a high level of performance by minimizing the number of recorded reclaim states (e.g., three reclaim states), for example.

Operations for various embodiments may be further described with reference to the following figures and accompanying examples. Some of the figures may include a logic flow. It can be appreciated that the logic flow merely provides one example of how the described functionality may be implemented. Further, the given logic flow does not necessarily have to be executed in the order presented unless otherwise indicated. In addition, the logic flow may be implemented by a hardware element, a software element executed by a processor, or any combination thereof. The embodiments are not limited in this context.

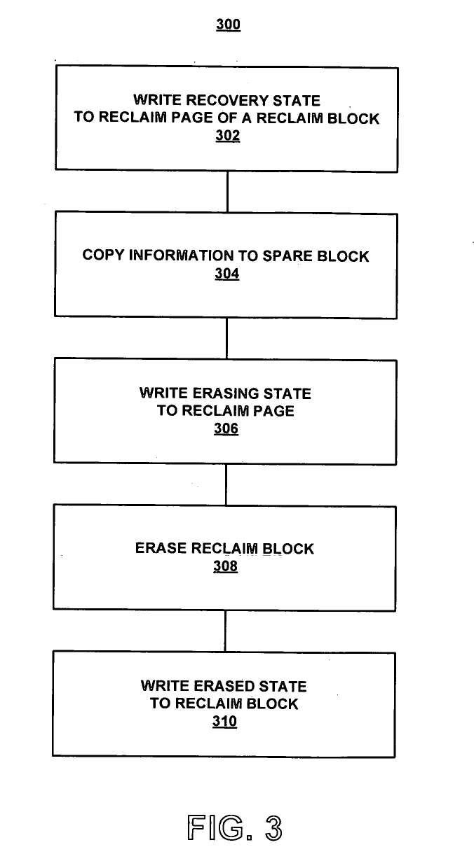

FIG. 3 illustrates one embodiment of a logic flow 300. FIG. 3 illustrates logic flow 300 for performing reclaim operations to recover nonvolatile memory space. In various embodiments, the logic flow 300 may be implemented by one or more elements of the computing a system 100 of FIG. 1 and/or the nonvolatile memory 200 of FIG. 2A-C. It can be appreciated that the logic flow 300 may be implemented by various other types of hardware, software, and/or combination thereof.

At block 302, the logic flow 300 may comprise writing a recovery state (e.g., BLK_RECOVER) to a reclaim page of a reclaim block. The reclaim page may comprise, for example, the last page of the reclaim block. In various embodiments, reclaim operations may be initiated by writing the recovery state to the reclaim page of the reclaim block.

At block 304, the logic flow 300 may comprise copying information to a spare block. In various embodiments, information stored in the reclaim block may be copied to a spare block. At the time reclaim operations begin, the spare block may be erased and contain no information. In some cases, the spare block may be designated for use only during the reclaim operations. The information may comprise, for example, header and other data contained in the reclaim block. In some implementations, the information may comprise only valid information.

At block 306, the logic flow 300 may comprise writing an erasing state (e.g., BLK_ERASING) to the reclaim page. In various embodiments, after the stored information has been copied from the reclaim block to the spare block, the erasing state may be written to the reclaim page of the reclaim block. The erasing state may be written to the reclaim page after, as opposed to on top of, the recovery state. Accordingly, bit-twiddling is avoided.

At block 308, the logic flow 300 may comprise erasing the reclaim block. In various embodiments, the reclaim block, including the reclaim page, may be erased to recover nonvolatile memory space.

At block 310, the logic flow 300 may comprise writing an erased state (e.g., BLK_ERASED) to the reclaim block. In various embodiments, the erased state may be written to the first page of the reclaim block to indicate that the reclaim block may be configured as a new spare block.

It can be appreciated that as writes occur, previous pages are not revisited and writes to the reclaim page do not violate sequential addressing restrictions and avoid bit-twiddling. It also can be appreciated that during power-loss recovery operations, a file system is able to recover using the states written to the reclaim page.

In various implementations, the described embodiments may comprise, or form part of a wired communication system, a wireless communication system, or a combination of both. Although certain embodiments may be illustrated using a particular communications media by way of example, it may be appreciated that the principles and techniques discussed herein may be implemented using various communication media and accompanying technology.

In various implementations, the described embodiments may comprise or form part of a network, such as a Wide Area Network (WAN), a Local Area Network (LAN), a Metropolitan Area Network (MAN), a wireless WAN (WWAN), a wireless LAN (WLAN), a wireless MAN (WMAN), a wireless personal area network (WPAN), a WiMAX network, a broadband wireless access (BWA) network, the Internet, the World Wide Web, a telephone network, a radio network, a television network, a cable network, a satellite network, a Code Division Multiple Access (CDMA) network, a third generation (3G) network such as Wide-band CDMA (WCDMA), a fourth generation (4G) network, a Time Division Multiple Access (TDMA) network, an Extended-TDMA (E-TDMA) cellular radiotelephone network, a Global System for Mobile Communications (GSM) network, a Synchronous Division Multiple Access (SDMA) network, a Time Division Synchronous CDMA (TD-SCDMA) network, an Orthogonal Frequency Division Multiplexing (OFDM) network, an Orthogonal Frequency Division Multiple Access (OFDMA) network, a North American Digital Cellular (NADC) cellular radiotelephone network, a Narrowband Advanced Mobile Phone Service (NAMPS) network, a Universal Mobile Telephone System (UMTS) network, and/or any other wired or wireless communications network configured to carry data. The embodiments are not limited in this context.

In various implementations, the described embodiments may be arranged to communicate using a number of different WWAN data communication services. Examples of cellular data communication systems offering WWAN data communication services may include a GSM with General Packet Radio Service (GPRS) systems (GSM/GPRS), CDMA/1×RTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, and so forth.

In various implementations, the described embodiments may be arranged to communicate in accordance with a number of wireless protocols. Examples of wireless protocols may include various WLAN protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may include various WWAN protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may include WPAN protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electro-magnetic induction (EMI) techniques. An example of EMI techniques may include passive or active radio-frequency identification (RFID) protocols and devices. Other suitable protocols may include Ultra Wide Band (UWB), Digital Office (DO), Digital Home, Trusted Platform Module (TPM), ZigBee, and other protocols.

In various implementations, the described embodiments may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an ASIC, PLD or DSP, and so forth. In yet another example, an embodiment may be implemented by any combination of programmed general-purpose computer components and custom hardware components.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising:
a nonvolatile memory to perform reclaim operations to recover memory space from a reclaim block containing stored information, said reclaim block associated with a reclaim page to store one or more reclaim states indicating progress of said reclaim operations.

2. The apparatus of claim 1, said nonvolatile memory comprising at least one of a NAND flash memory and a NOR flash memory.

3. The apparatus of claim 1, said reclaim page comprising a last page of said reclaim block.

4. The apparatus of claim 1, said one or more reclaim states comprising at least one of a recovery state, an erasing state, and a bad block state.

5. The apparatus of claim 1, said reclaim block to store an erased state to indicate completion of said reclaim operations.

6. A system comprising:
a wireless interface comprising an antenna; and
a nonvolatile memory to perform reclaim operations to recover memory space from a reclaim block containing stored information, said reclaim block associated with a reclaim page to store one or more reclaim states indicating progress of said reclaim operations.

7. The system of claim 5, said nonvolatile memory comprising at least one of a NAND flash memory and a NOR flash memory.

8. The system of claim 5, said reclaim page comprising a last page of said reclaim block.

9. The system of claim 5, said one or more reclaim states comprising at least one of a recovery state, an erasing state, and a bad block state.

10. The system of claim 5, said reclaim block to store an erased state to indicate completion of said reclaim operations.

11. A method, comprising:
writing one or more reclaim states to a reclaim page associated with a reclaim block containing stored information, said reclaim states indicating progress of reclaim operations to recover memory space.

12. The method of claim 11, comprising writing at least one of a recovery state, an erasing state, and a bad block state to said reclaim page.

13. The method of claim 11, comprising writing reclaim states one after another to said reclaim page.

14. The method of claim 11, comprising writing said one or more reclaim states in compliance with a sequential addressing requirement.

15. The method of claim 11, comprising writing an erased state to said reclaim block.

16. An article comprising a machine-readable storage medium containing instructions that if executed enable a system to:
write one or more reclaim states to a reclaim page associated with a reclaim block containing stored information, said reclaim states indicating progress of reclaim operations to recover memory space.

17. The article of claim 16, further comprising instructions that if executed enable a system to write at least one of a recovery state, an erasing state, and a bad block state to said reclaim page.

18. The article of claim 16, further comprising instructions that if executed enable a system to write reclaim states one after another to said reclaim page.

19. The article of claim 16, further comprising instructions that if executed enable a system to write said one or more reclaim states in compliance with a sequential addressing requirement.

20. The article of claim 16, further comprising instructions that if executed enable a system to writing an erased state to said reclaim block.
